(19) United States
(12) Patent Application Publication
(10) Pub. No.: US 2015/0107423 A1
(43) Pub. Date: Apr. 23, 2015

(54) UNIVERSAL WRENCH

(71) Applicant: Actervis GmbH, Baar/Zug (CH)

(72) Inventor: Juan Ramón Torres Martín, Barcelona (ES)

(21) Appl. No.: 14/521,215

(22) Filed: Oct. 22, 2014

Related U.S. Application Data
(60) Provisional application No. 61/894,179, filed on Oct. 22, 2013.

(51) Int. Cl. B25B 23/16; B25G 1/04

(52) U.S. Cl. CPC B25B 23/16; B25G 1/043
USPC 81/177.2

(57) ABSTRACT

By configuring a universal wrench with a spanner at one end, and a combined dual piece handle structure, a universal tool is achieved which is extremely useful and versatile. A two piece handle structure includes a removable extension or second handle portion which can be removably attached to a first handle portion. When removed, the wrench is of a relatively compact size, thus allowing access and usability in tight quarters. When the handle portion is combined, the universal wrench has an increased length, thus allowing additional torque to be applied to any bolt or nut being worked on.

The present application claims the benefit of U.S. Provisional Patent Application 61/894,179 entitled “Universal Wrench” and filed on Oct. 22, 2013, which is incorporated herein by reference.

### BACKGROUND

Effective and useful universal tools are desired by mechanics, homeowners, and virtually anyone needing a single tool capable of many different functions. Individuals working on mechanical devices and structures have a continual need to remove and/or attach bolts, screws, nuts, fasteners, etc., and the size of these components is often unpredictable. As such, universal tools and universal wrenches are very useful, since this eliminates the need to have many different tools in a toolbox and on hand at all times.

In addition to the general utility provided by universal tools, there is often an unpredictable need for various levels of strength and leverage. Obviously, the size of a particular tool will largely dictate its effectiveness and usefulness for a particular purpose. For example, a larger wrench (i.e., longer) can easily provide more strength and leverage when working with fasteners. A larger wrench is not always appropriate, however, especially when working in smaller spaces or with smaller fasteners. Conversely, the use of smaller tools or wrenches may not provide the necessary level of leverage or torque.

Based upon the issues outlined above, a universal wrench which could be adapted for various situations, provides a useful addition to any toolbox. Such a wrench would provide a single tool which is useful in a wide variety of situations.

### SUMMARY

In various embodiments of the present invention, a universal wrench is provided which is adaptable to many different situations and generally appropriate for the type of work being done. To provide the necessary functionality, the universal wrench has a wrench mechanism (i.e. spanner), capable of interacting with many different fasteners. In addition, a handle structure is provided which can be adjusted to fit the situation. In one embodiment, the handle can easily be separated to a smaller length, when work in tighter spaces is required or a less sizable wrench is desired. Similarly, a longer length handle configuration can be used when additional leverage and strength is required. These features, among others, are generally achieved by utilizing a two-part handle which can be selectively separated, to provide the desired size and strength. A first handle portion is configured to have the wrench mechanism attached to a first end, and a first handle portion on an opposite end. Further, this first handle portion includes a receiving slot on the end opposite the wrench mechanism. The universal wrench also includes a second handle portion having an extension extending from one end thereof. Both the first handle portion and second handle portion have gripping structures to allow a user to conveniently grasp the wrench. Additional features of the second handle portion may be included at an opposite end (i.e. opposite the extension). Most significantly, the extension is uniquely configured to be engaged with the receiving slot. Stated differently, the extension and receiving slot provide a coupling mechanism between these two components. The extension may further include a spring-loaded mechanism to capture and retain the extension in a predetermined position.

In summary, the universal wrench with a handle structure having two portions, as outlined in the various embodiments described herein, provides an adjustable and useful wrench with the ability to be effectively used for many different situations.

### BRIEF DESCRIPTION OF THE DRAWINGS

Further advantages of the universal wrench will be understood by reading the following detailed description, in conjunction with the drawings, in which:

FIG. 1 is a perspective view of the example universal with the two handle portions separated;

FIGS. 2 and 3 are opposite side views of the universal wrench shown in FIG. 1;

FIGS. 4 and 5 are bottom and top views, respectively, of the wrench illustrated in FIG. 1;

FIGS. 6 and 7 are first and second end views of the wrench illustrated in both FIGS. 1 and 8;

FIG. 8 is a perspective view of the universal wrench illustrated when the two handled portions are connected to one another;

FIGS. 9 and 10 are opposite side views of the wrench shown in FIG. 8;

FIGS. 11 and 12 are bottom and top views, respectively, of the wrench shown in FIG. 8.

### DESCRIPTION OF THE PREFERRED EMBODIMENTS

In the description below, and the attached Figures, the features and characteristics of one embodiment of a universal wrench 10 are further outlined. Generally wrench 10 includes a wrench mechanism, or spanner, 20 which is capable of universally interacting with nuts, bolts, screws and various fasteners of many different types. In addition, wrench 10 includes a handle structure 30 adapted and configured to increase the versatility of the tool. As further detailed below, handle 30 includes a first portion 32 and a second portion 34 to provide additional features and unique capabilities.

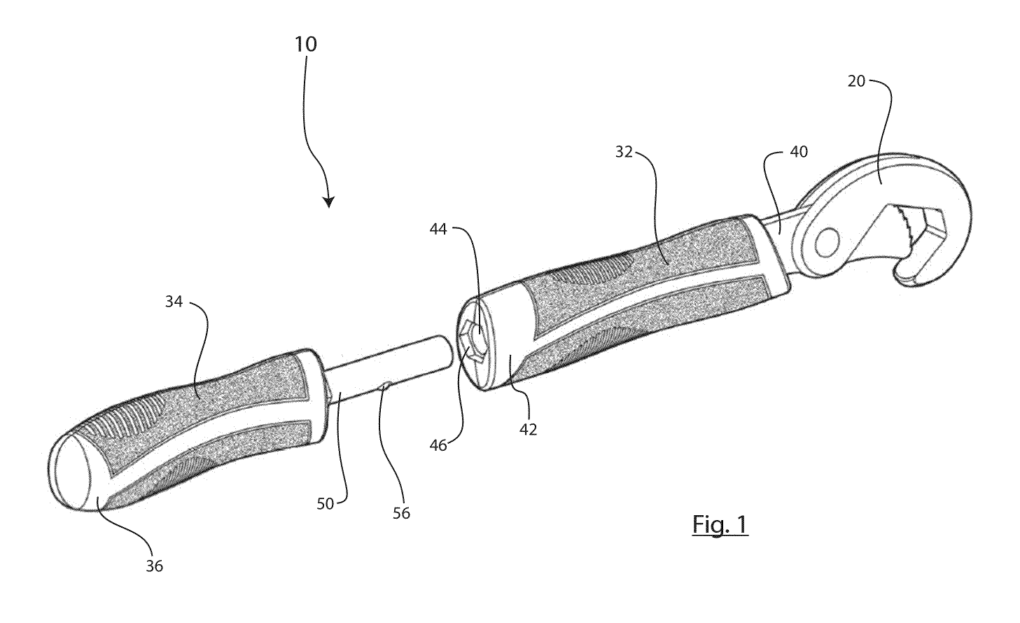

Referring now to the figures, FIG. 1 illustrates a perspective view of the wrench 10 having the features and characteristics described herein. Again, universal wrench 10 includes a wrench structure or spanner 20 situated at one end thereof. In addition, the universal wrench 10 includes a handle 30 designed to allow a user to easily access and manipulate the tool.

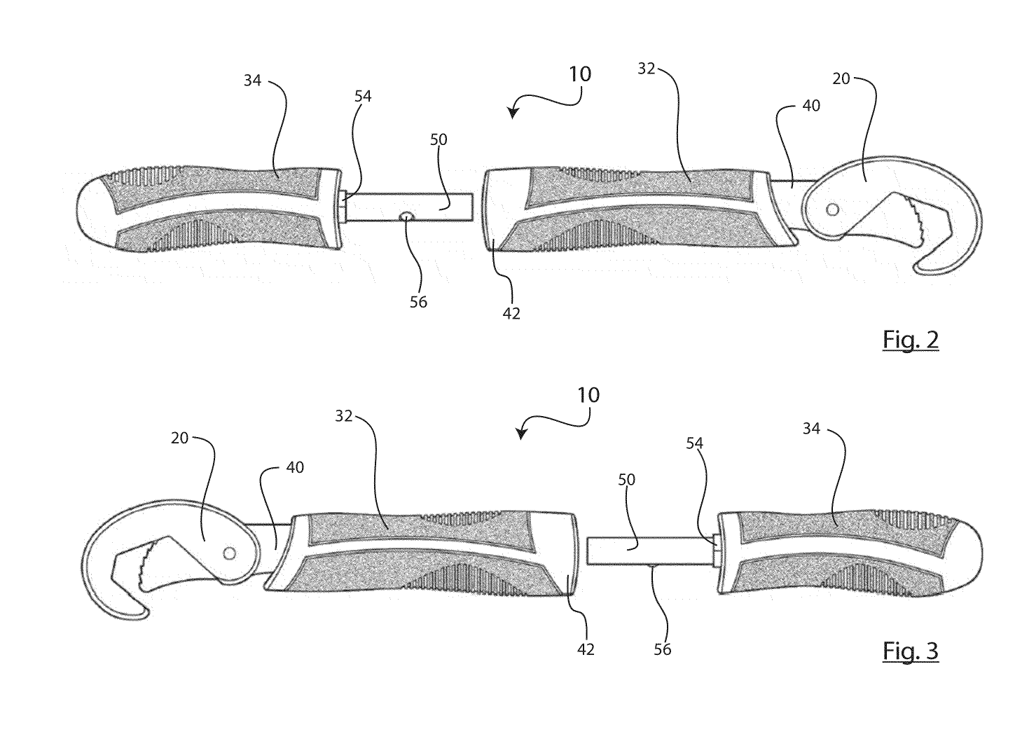

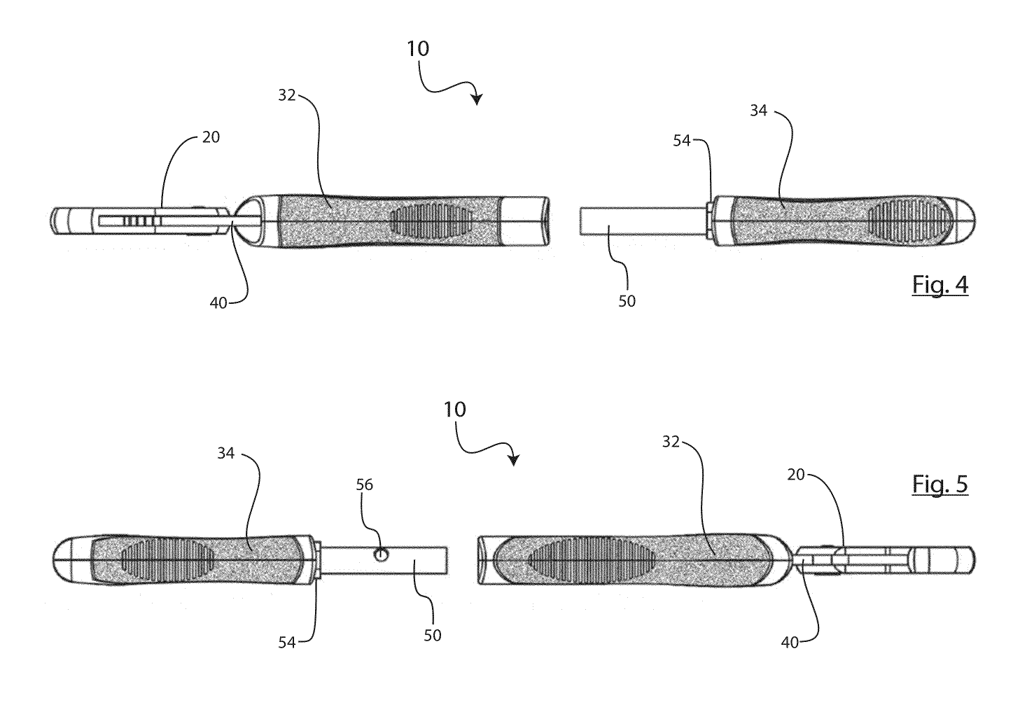

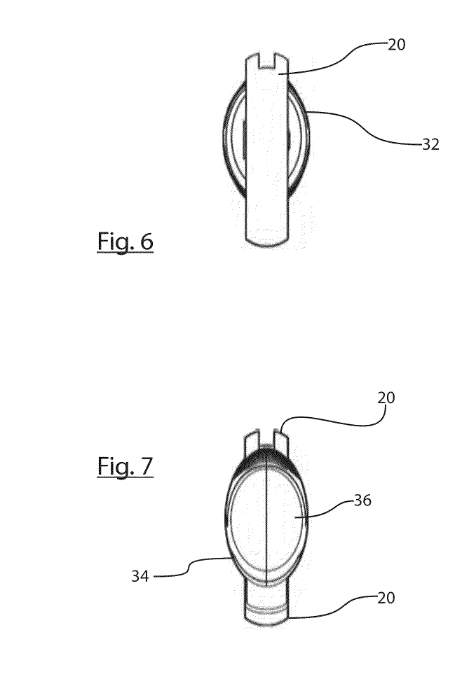

FIGS. 1-7 illustrate universal wrench 10 with the handle 30 separated into two components. Referring now to first handle portion 32, a central shaft 40 runs through the middle of a molded handle portion 42. As shown, central shaft 40 is only partially visible at one end, as it has been encased by molded handle portion 42. The central shaft 40 is preferably constructed of carbon steel, while the handle is made of a combination of polypropylene and TPR configured to provide a desired gripping structure.

Again, attached to a first end of central shaft 40 is the wrench structure or spanner 20. Central shaft 40 also includes a cutout or recess 44 is positioned at an end opposite coupling structure 20. Again, it is understood that a grip structure 42 will surround and enclose central shaft 40, while allowing recess 44 to be accessible. As further described below, recess 44 accommodates the attachment of second handle portion 34 when desired.

As also illustrated in FIGS. 1-7, second handle portion 34 includes an extension 50 and a molded grip or handle portion 36. As it clearly illustrated, extension 50 is sized and configured to be received within recess 44, thus creating a removable coupling between these two portions. As will be recognized, extension 50 is part of a central structure (not shown) which exists within second handle portion 34.

As further illustrated, extension 50 further includes a coupling ball 56 designed to further accommodate the attachment of extension 50 within recess 44. This coupling ball 56 is typically a spring loaded ball, which is simply designed to snap within a related recess within the handle or grip portion 42 (not shown) to hold extension 50 within recess 44.

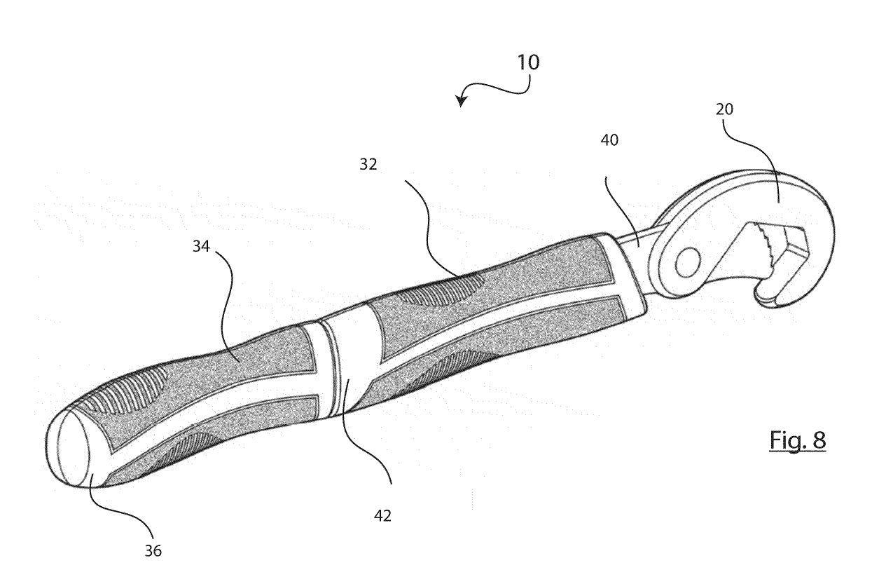

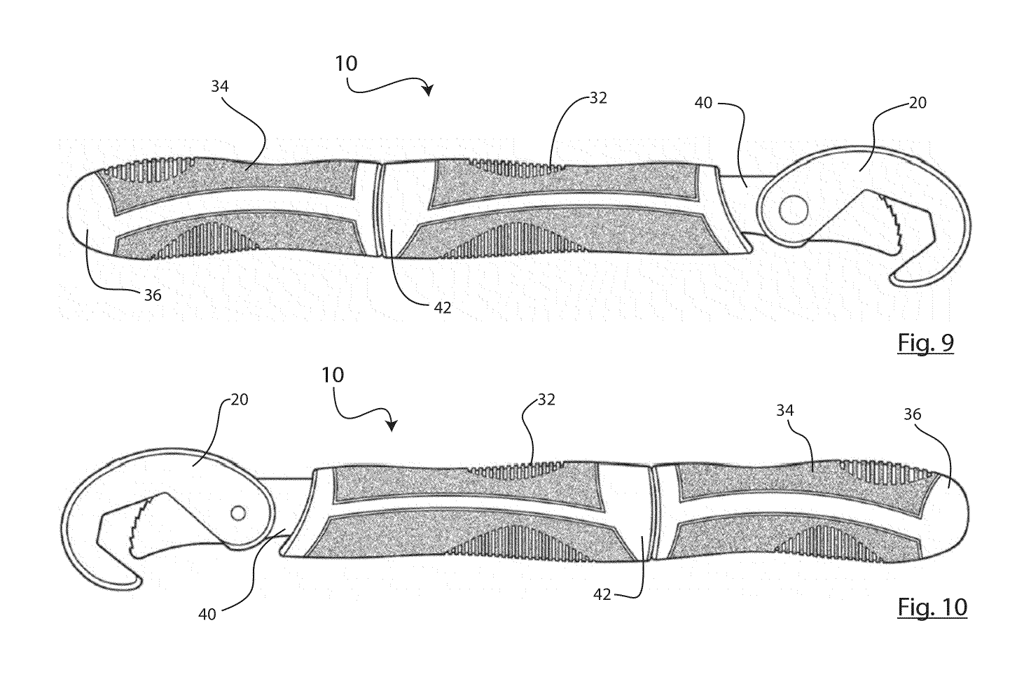

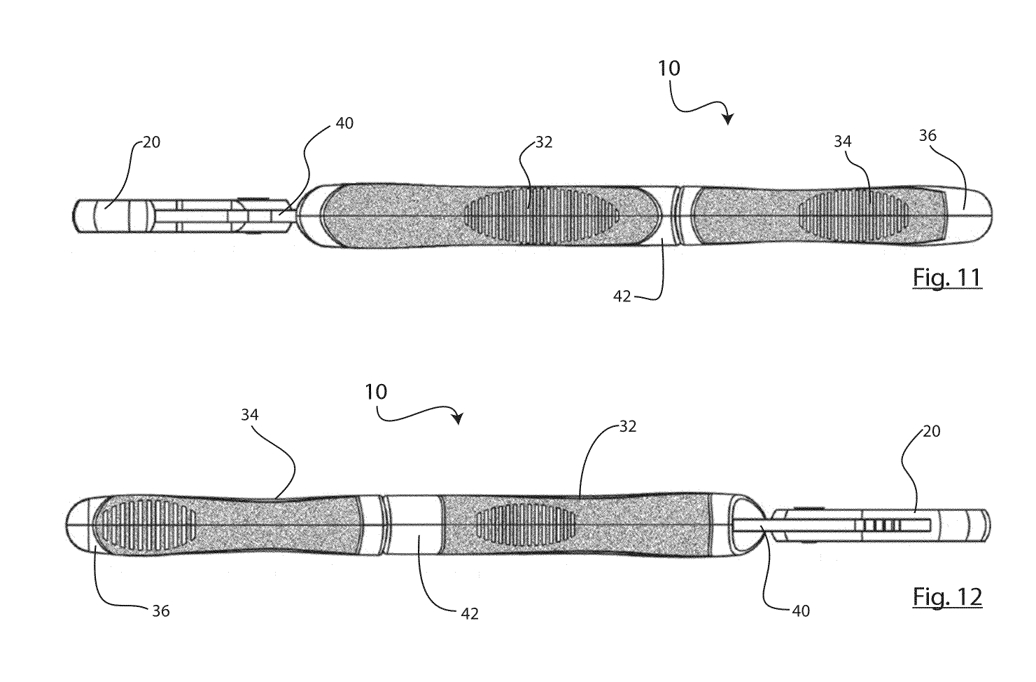

As can be appreciated, when second handle portion 34 is attached or coupled with first handle portion 32, the overall length of the universal wrench 10 is increased. This is best illustrated in FIGS. 8-12. Naturally, increased length provides the ability to exert additional force and leverage upon the necessary fastener or connector. Alternatively, when less leverage is necessary, or it is necessary to work in smaller spaces, second handle portion 34 can be removed to provide a more compact universal wrench.

As mentioned above, first handle portion 32 include recess 44 configured to receive and capture extension 50. At an initial portion of recess 44 a coupling structure 46 exists to provide a more complete, in this particular example, coupling structure 46 includes a hexagonal recess which extends into first handle portion 32 a predetermined distance. A similar hexagonal structure 54 exists at an near edge of shaft 50. As will be appreciated, once shaft 50 is inserted into recess 44, the related hexagonal structure 54 and hexagonal coupling structure 46 will interact with one another to provide a close coupling between these two elements. Most significantly, these related interacting coupling structures will prevent twisting or rotation of first handled portion 32 with respect to the second handle portion 34. As appreciated, this will increase the strength and functionality of universal wrench 10 when in the extended or lengthened configuration.

Based upon the features outlined above, and illustrated in the various figures, it is clear that the universal wrench can combine a large number of unique characteristics to achieve versatility that is not present in existing products. Having the spanner 20 configured at one end of the universal wrench 10, which is adapted to interact with many different bolt sizes and structures provides a well-known feature that increases utility and functionality. In addition, the combined first handle portion 32 and second handle portion 34 clearly provide the ability to adjust the length, and overall leverage achieved by universal wrench 10. The coupling structure is uniquely configured so that it is robust and capable of applying the necessary leverage. These features, coupled with a comfortable grip structure, provides a tool which is uniquely configured to be easily adapted and usable in many circumstances.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A universal wrench comprising:
a first tool member having a handle portion at a first end and a spanner at an opposite end, the handle portion having a receiving chamber at the first end; and
a second tool member having a second handle portion configured to match the first handle portion, and an attachment extension at a first end thereof, the attachment extension insertable into the receiving chamber to removably couple the second tool member to the first tool member thereby providing additional leverage to the spanner when attached thereto, the first handle portion and the second handle portion matched to form a substantially continuous and smooth outer surface when attached.

2. The universal wrench of claim 1 wherein the attachment extension has a first portion which is substantially cylindrical and a second portion which has a hexagonal outer surface, and wherein an interior wall surface of the receiving chamber has a cooperating configuration so as to closely receive the attachment extension.

3. The universal wrench of claim 2 wherein the attachment extension further comprises a spring loaded ball and the receiving slot further comprises a receiving groove configured to receive the spring loaded ball when the extension is inserted into the receiving slot, thereby retaining the coupling between the first handle portion and the second handle portion until a minimum pulling force is applied.

4. The universal wrench of claim 3 wherein the coupling between the second portion of the attachment extension and the receiving chamber prevents rotation of the first tool member with respect to the second tool member.

5. The universal wrench of claim 1 wherein the first tool member comprises central shaft portion encased within the surrounding handle portion, and wherein the central shaft portion of the first handle members includes the receiving chamber therein and forms a portion of the spanner, the central shaft portion of the first handle portion being formed of a material more rigid than the surrounding handle portion.

6. The universal wrench of claim 5 and the second tool member wherein the second tool member comprises central shaft structure including the attachment extension which is surrounded by the handle portion, wherein the central shaft structure of the second tool member is formed of a material matching the material of the central shaft portion of the first tool member.

7. A universal wrench configured for use on many different fasteners, comprising:
a first handle member having a central shaft, a grip structure substantially surrounding the central shaft, and a receiving portion positioned at a first end;
a wrench mechanism attached to a second end of the first handle portion, wherein the second end is opposite the first end, the wrench mechanism adapted to engage predetermined structures on the fasteners;
a second handle member having a central shaft, a grip structure substantially surrounding the central shaft and a connection extension extending from an end of the second handle member, wherein the connection extension is configured to have a predetermined configuration, and the receiving portion of the first handle member is configured to have a cooperating structure so that the extension can be removably received within the receiving opening; and
a retaining component cooperating with the connection extension and the receiving slot so as to retain a coupled connection between the first handle member and the second handle member.

8. The universal wrench of claim 7 wherein the predetermined configuration for the connection extension and the receiving portion is substantially cylindrical.

9. The universal wrench of claim 8 wherein the connection section has a base portion and an extended portion, wherein the base portion is substantially hexagonal, and the extended portion maintains the substantially cylindrical configuration, and wherein the receiving portion has a substantially hexagonal opening at an initial portion, such that the hexagonal portion of the receiving slot and the hexagonal portion of the extended portion couple with one another when the ended portion is fully inserted into the receiving portion.

10. The universal wrench of claim 7 wherein the retaining component is a spring loaded ball member inserted into a recess in the connection extension.

11. The universal wrench of claim 10 wherein the receiving portion includes a recess sized and configured to receive the spring loaded ball member.

12. The universal wrench of claim 7 wherein the grip structure of the first handle member and the grip structure of the second handle member are sized so the outer surfaces align with on another co create a continuous outer handle surface.

13. The universal wrench of claim 12 wherein the grip structure of the first handle member and the grip structure of the second handle member each include at least one gripping section formed of a material which is softer than a material forming the remainder of the grip structure.

14. A universal wrench for use in conjunction with a fastener, comprising:
a first handle member having a central shaft, a grip structure substantially surrounding the central shaft and having at least one gripping section formed of a material softer than a material forming the remainder of the grip structure, the first handle member further having a substantially cylindrical receiving portion positioned at a first end thereof, with an initial section of the receiving portion being a non-cylindrical;
a wrench mechanism attached to a second end of the first handle portion, wherein the second end is opposite the first end, the wrench mechanism adapted to engage predetermined structures on the fasteners;
a second handle member having a central shaft, a grip structure substantially surrounding the central shaft and having at least one gripping section formed of a material softer than a material forming the remainder of the grip structure, the second handle member having a substantially cylindrical connection extension extending from an end of the second handle member, with the connection extension further including a non-cylindrical portion at a base thereof, wherein the connection extension and the receiving portion of the first handle member are configured to allow the extension can be removably received within the receiving opening thus causing the first handle member and the second handle member to be substantially aligned with one another; and
a retaining component cooperating with the connection extension and the receiving slot so as to retain a coupled connection between the first handle member and the second handle member;
wherein the grip structure of the first handle member and the grip structure of the second handle member are sized so the outer surfaces align with on another co create a substantially continuous outer handle surface.

15. The universal wrench of claim 14 where the retaining component is a spring loaded ball member inserted into a recess in the connection extension and is positioned to be received within an opening within the receiving opening.
